(19) United States
(12) Patent Application Publication
(10) Pub. No.: US 2005/0266875 A1
(43) Pub. Date: Dec. 1, 2005

(54) Integrated SDARS headphone system

(76) Inventors: Korkut Yegin, Grand Blanc, MI (US); Daniel G. Morris, Ovid, MI (US); Elias H. Ghafari, Rochester Hills, MI (US); Loren M. Thompson, Lapeer, MI (US); William R. Livengood, Grand Blanc, MI (US)

Correspondence Address: DELPHI TECHNOLOGIES, INC., M/C 480-410-202, PO BOX 5052, TROY, MI, 48007, US

(21) Appl. No.: 10/999,384

(22) Filed: Nov. 30, 2004

Related U.S. Application Data
(60) Provisional application No. 60/574,480, filed on May 26, 2004.

(51) Int. Cl. H04B 1/38

(52) U.S. Cl. 455/552.1

(57) ABSTRACT

An integrated antenna module includes an antenna element configured to receive satellite digital audio radio signals, an amplifier, and a ground plane. The antenna module may be integrated into a headphone assembly configured to receive satellite digital audio radio signals.

### CROSS REFERENCE TO RELATED APPLICATION

This application claims priority to U.S. provisional application 60/574,480 filed on May 26, 2004, which is incorporated herein by reference in its entirety.

### TECHNICAL FIELD

The present invention relates generally to antenna systems for satellite digital audio radio service communications and more specifically to an antenna module incorporated into a headphone assembly for satellite digital audio radio service.

### BACKGROUND

Satellite digital audio radio service (SDARS) involves broadcasting audio programming signals from space satellites (orbiting the Earth) and earth-based terrestrial towers. The receiving devices decode the broadcast signals into audio sounds, such as music and other types of audio programming commonly available on conventional radios. A receiving device for receiving SDARS signals typically includes an antenna with a low-noise amplifier, and a receiver. Additionally, a ground plane is coupled to the antenna for antenna performance. While SDARS has been utilized in automobiles and residential settings, the size of the components comprising the typical SDARS receiving device—particularly the ground plane size for reception—has made it impractical for purposes of personal mobile SDARS devices.

The inventors hereof have recognized a need for a personal mobile SDARS device.

### SUMMARY

The present invention is directed to a mobile wearable audio system capable of receiving satellite digital audio radio (SDARS) signals. The system includes an antenna module that receives broadcasted SDAR signals. The antenna module includes an antenna element, a ground plane, and an amplifier. The antenna module is integrated into a portable headphone assembly.

### BRIEF DESCRIPTION OF THE DRAWINGS

FIG. 1 illustrates an integrated SDARS headphone system according to an embodiment of the present invention.

FIG. 2 illustrates a more detailed view of the integrated SDARS headphone system in FIG. 1.

FIG. 3 illustrates another embodiment of an integrated SDARS headphone system.

FIG. 4 illustrates another embodiment of an integrated SDARS headphone system.

FIG. 5 illustrates another embodiment of an integrated SDARS headphone system.

### DETAILED DESCRIPTION

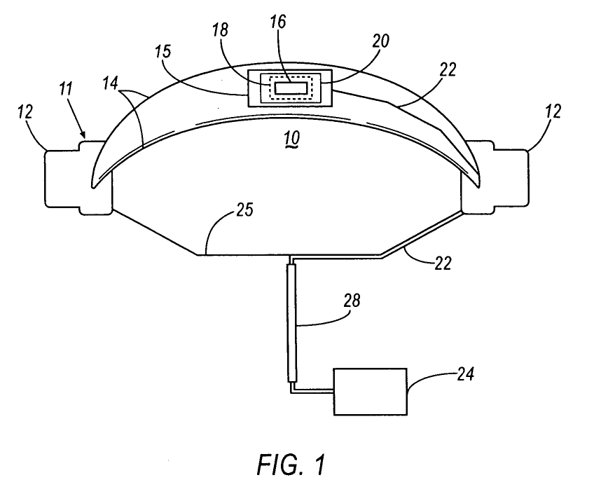

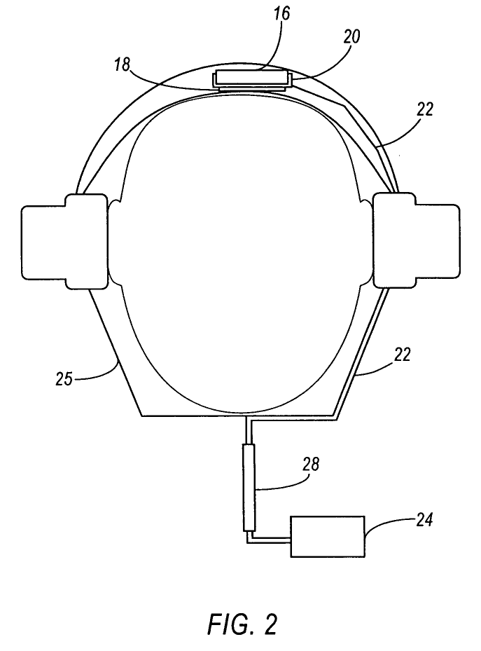

FIG. 1 illustrates an embodiment of an integrated SDARS headphone system 10. The integrated SDARS headphone system 10 generally includes a headphone assembly 11 and an SDARS receiver 24. The headphone assembly 11 is configured to allow a user to wear the assembly on his/her head in a manner generally shown in FIGS. 1-2. The SDARS receiver 24 may be electrically connected (as shown in FIG. 1 and as described hereinbelow) to permit the receiver to be remotely located from the headphone assembly 11, such as clipped to the user's belt, for example.

The headphone assembly 10 includes ear pieces 12 and a headstrap 14. The headstrap 14 is connected between ear pieces 12 so as to secure placement of the headphone assembly 10 on the head of a user. Each ear piece 12 includes a speaker (not shown) for delivering audio to a user. The ear pieces 12 are coupled to an SDARS receiver 24 by audio cables 25.

An antenna module 15 is coupled to the headstrap 14 using a variety of possible methods available to a person skilled in the art. For instance, the antenna module 15 may be integrally molded into the headstrap 14. Alternatively, the antenna module 15 may be attached to the headstrap 14 by way of a tongue-and-groove arrangement between the antenna module 15 and the headstrap 14. A person skilled in the art will recognize a variety of acceptable methods of attaching the antenna module 15 to the headstrap 14. The antenna module 15 is configured to receive radio frequency signals transmitted via a satellite digital audio radio service, such as XM® Satellite Radio, for example. The antenna module 15 includes an antenna element 16, an amplifier 18, and a ground plane 20, described in more detail hereinbelow.

An SDARS receiver 24 is electrically connected to antenna module 15 via transmission line 22. The SDARS receiver 24 is further electrically connected to ear pieces 12 via audio lines 25. In some embodiments, portions of the coaxial cable 22 and audio lines 25 may be wrapped together in a single cable 28 for convenience of the user. The coaxial cable 22 and audio lines 25 may comprise a variety of transmission lines, such as single copper wires, twisted pair wires, etc. The transmission line 22 and the audio lines 25 may be sufficiently long to permit the receiver 24 to be remotely located from the headphones, such as clipped to the user's belt.

Antenna element 16 may be a patch, helical or other type of antenna that is known in the art. In some embodiments, the antenna element 16 is mounted to the headphone assembly such that the antenna element 16 is tilted away from the user's head during normal usage so as to increase the gain of the antenna and optimize reception.

Amplifier 18 amplifies a predetermined frequency of signals received by the antenna element 16 for processing by the receiver 24. As such, amplifier 18 may be a low-noise amplifier that amplifies satellite signals, for example, as low as −110 dBm. The amplifier 18 is relatively small in size so as to enable packaging of the amplifier 18 and other components within the headphone assembly 10. Specifically, the amplifier 18 preferably (though not necessarily) occupies an area less than 900 mm². In one embodiment, the amplifier 18 has an area of about 625 mm². The antenna element 16 and the amplifier 18 are electrically connected to permit communication of received signals from the antenna element 16 to the amplifier 18.

Ground plane 20 provides a radio-frequency ground for the antenna element 16. The ground plane 20 may be constructed from a metal material. Preferably, the ground plane 20 forms a recessed cavity over which the antenna element 16 is positioned. The recessed cavity of the ground plane 20 may have a depth ranging from about 3 mm-4 mm, for example.

Though not shown in FIG. 2, antenna module 15 may be movable relative to the headphone strap 14 to enable a user to manually adjust the position of the antenna module 15 to achieve enhanced reception, depending on the location of the user. For example, headphone strap 14 could be equipped with a groove and the antenna module 15 could include a pin that slidably engages with the groove to permit the antenna module 15 to be slid from one end of the headphone strap to the other between the ear pieces 12. Indeed, in some embodiments, the antenna module 15 may be entirely detachable from the headphone assembly 11 to enable the user to have ultimate flexibility to position the antenna module 15 for optimal reception. A person skilled in the art will recognize other acceptable mechanisms for moveably and/or detachably mounting the antenna module 15 in light of this disclosure. Furthermore, though shown in FIGS. 1 and 2 as being mounted to the headphone strap 14, the antenna module 15 may be mounted to or integrated with other portions of the headphone assembly 11, such as in the ear pieces 12, for example.

The antenna element 16 and the amplifier 18 are preferably (though not necessarily) mounted on opposite sides of the ground plane 20 to isolate the antenna element 16 from radio-frequency interference generated by the user's head, thereby increasing reception efficiency of the antenna element 16. For similar reasons, the amplifier 18 is preferably (though not necessarily) positioned more proximate to the head of the user than the antenna element 16. Additionally, because the antenna element 16 is designed to operate in a relatively close proximity to the user, the antenna element 16 typically requires tuning for optimal reception of the satellite signal. The antenna element 16 may be tuned by capacitive loading.

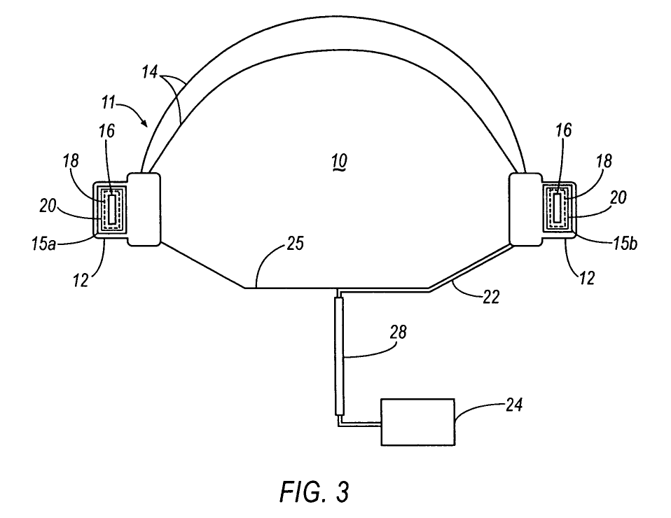

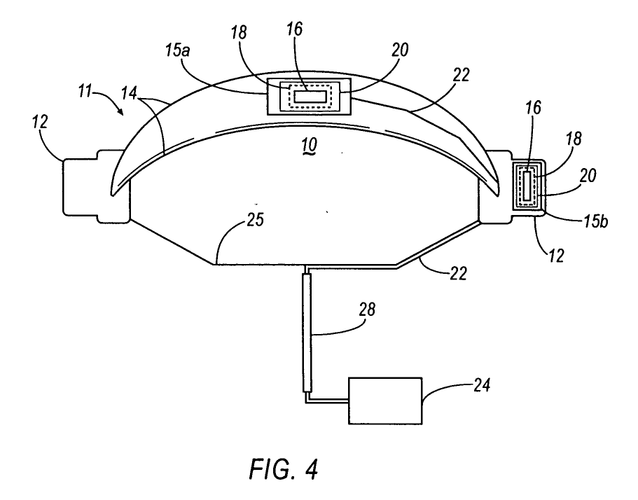

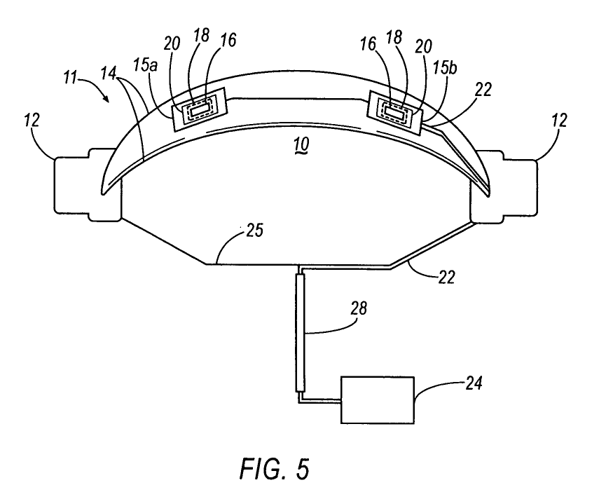

To even further enhance the reception capabilities of the SDARS headphone system 10, multiple antenna modules can be used. FIGS. 3-5 illustrate exemplary embodiments (where like elements have like reference numerals) that use multiple antenna modules 15(a) and 15(b) to enhance reception. In FIG. 3, antenna modules 15(a) and 15(b) are incorporated into the respective ear pieces 12. FIG. 4 illustrates an embodiment where one of the antenna modules 15(a) is incorporated into the headphone strap 14 and another antenna module 15(b) is incorporated into an ear piece 12. Finally, FIG. 5 illustrates an embodiment where two antenna modules 15(a) and 15(b) are coupled to the headphone strap 14. As described above in connection with the embodiment of FIG. 2, the antenna modules 15(a) and 15(b) may be configured to be movable and/or detachable to enhance the ability of the user to optimize reception.

In operation, each of the embodiments function similarly. Specifically, satellite broadcast signals are received by the antenna element 16 (either directly from satellites or via terrestrial transmitters) and amplified by amplifier 18. The amplified signals are transmitted to the receiver 24 via transmission line 22. The receiver 24 decodes the digital signal. In embodiments having multiple antenna modules 15, the receiver determines which of the received signals is stronger and uses it in the generation of the audio signals. The decoded audio signal is transmitted to the ear-piece 12 via the audio lines 25 to drive the speakers (not shown).

Various other modifications to the present invention may occur to those skilled in the art to which the present invention pertains. Other modifications not explicitly mentioned herein are also possible and within the scope of the present invention. It is the following claims, including all equivalents, which define the scope of the present invention.

1. An integrated antenna module, comprising:
an antenna element configured to receive satellite digital audio radio signals;
an amplifier; and
a ground plane disposed between said antenna element and said amplifier.

2. An antenna module according to claim 1, wherein said antenna element is a patch antenna.

3. An antenna module according to claim 1, wherein said antenna element is a helical antenna.

4. An antenna module according to claim 1, wherein said amplifier is a low-noise amplifier.

5. An antenna module according to claim 1, wherein said amplifier has an area of less than 900 mm².

6. An antenna module according to claim 1, wherein said ground plane forms a recessed cavity; and wherein said antenna element is mounted over said cavity.

7. An antenna module according to claim 6, wherein said recessed cavity has a depth ranging from 3 mm to 4 mm.

8. An integrated antenna module, comprising:
an antenna element configured to receive satellite digital audio radio signals;
a ground plane that forms a recessed cavity; and
wherein said antenna element is mounted over said recessed cavity.

9. The antenna module of claim 9, further comprising an amplifier disposed on a side of said ground plane opposite said antenna element.

10. A satellite digital audio radio signals headphone system, comprising:
a headphone assembly having a headstrap and at least one ear piece; and
an antenna module configured to receive satellite digital audio radio signals, said antenna module being directly coupled to said headphone assembly.

11. The headphone system of claim 11, wherein said antenna module is integrally molded with a portion of said headphone assembly.

12. The headphone system of claim 11, wherein said antenna module is mechanically attached to said headphone assembly.

13. The headphone system of claim 11, wherein said antenna module is detachably coupled to said headphone assembly.

14. The headphone system of claim 11, wherein said antenna module is configured to be positionally-adjusted relative to headphone assembly.

15. The headphone system of claim 11, wherein said antenna module comprises:
an antenna element configured to receive satellite digital audio radio signals;
a ground plane that forms a recessed cavity; and
wherein said antenna element is mounted over said recessed cavity.

16. The headphone system of claim 11, wherein said antenna module includes an antenna element that is mounted to said headphone assembly so as to be tilted away from a user's head during normal operation.

17. The headphone system of claim 11, comprising at least two antenna modules directly coupled to said headphone assembly.

18. The headphone system of claim 11, wherein said antenna module is directly coupled to a headstrap of said headphone assembly.

19. The headphone system of claim 11, wherein said antenna module is directly coupled to an earpiece of said headphone assembly.

20. The headphone system of claim 11, wherein said antenna module includes an antenna element of the type selected from the following group: patch antenna and helical antenna.

21. The headphone system of claim 11, further comprising a receiver electrically connected to said antenna module and configured to receive and process satellite digital audio radio signals.
